(19) United States
(12) Patent Application Publication
(10) Pub. No.: US 2002/0197995 A1
(43) Pub. Date: Dec. 26, 2002

(54) Method and apparatus for conditioning wireless transmission of messages

(76) Inventors: Alex D. Starkovich, Gilbert, AZ (US); Bhaktha R. Kechavachar, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/891,592

(22) Filed: Jun. 25, 2001

(51) Int. Cl. H04Q 7/20

(52) U.S. Cl. 455/445; 455/422

(57) ABSTRACT

Briefly, in accordance with one embodiment of the invention, a portable communication device has a memory and a processor. The portable communication device may transmit a message upon the occurrence of a user defined event.

### BACKGROUND

Although current wireless communication systems (i.e. cellular systems) do offer flexibility in that they allow a user to be mobile while communicating, they still suffer from the limitation in that they operate in real-time. For example, the user may communicate using the wireless communication system only when the user is connected to the wireless system with their portable communication device (i.e., cell phone). Thus, delivery of content (e.g., messages, data, music, news, etc.) occurs in real-time when the user is connected to the wireless communication system.

This may be disadvantageous if the user needs to transmit or receive time sensitive information. For example, if the user wants to transmit a message (e.g. a press release) at a certain time, then the use must wait until that particular time, connect to the wireless communication system, and then transmit the message.

Real-time delivery may also be disadvantageous if the user is roaming throughout the wireless communication system such that characteristics such as quality of service, level of service, transmission power level, cost, etc. are changing. Consequently, the real-time delivery of content over a wireless communication system may subject the user to the current transmission characteristics. Thus, the user may not have the flexibility in determining when a message will be transmitted to take advantage of lower transmission cost, lower transmission power level, or better quality of service that may occur in the future.

Thus, there is a continuing need for better ways to transmit messages to and from a portable communication device

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a portable communication device as it may operate to communicate with a wireless communication system; and

FIG. 2 is a flow chart of a method of transmitting a message in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

It should be understood that embodiments of the present invention may be used in a variety of applications. Although the present invention is not limited in this respect, the techniques disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks, and the like.

Types of cellular radiotelephone communication systems intended to be within the scope of the present invention include, although not limited to, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

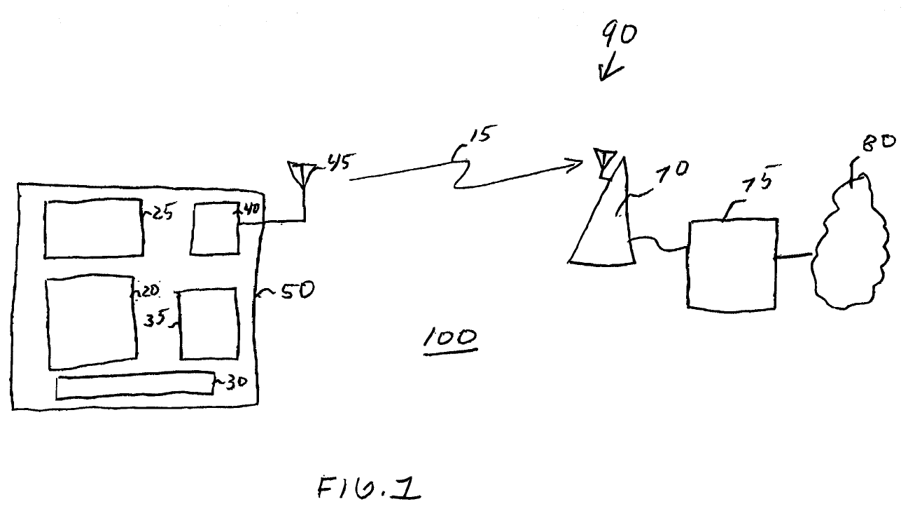

Turning to FIG. 1, an embodiment 100 in accordance with the present invention is described. Embodiment 100 may comprise a portable communication device 50 such as a mobile communication device (e.g., cell phone), a two-way radio communication system, a one-way pager, a two-way pager, a personal communication system (PCS), a portable computer, or the like. Although it should be understood that the scope and application of the present invention is in no way limited to these examples.

Portable communication device 50 may include a processor 20, a display 25, an input/output (I/O) device 30 (e.g. a keypad or the like), memory 35, and a transmitter 40 that may be connected to an antennae 45, although the scope of the present invention is not limited to embodiments have any or all of these components.

As explained in more detail below, memory 25 may be used to store messages transmitted to or by portable communication device 50. Memory 35 may also optionally be used to store instructions that are executed by processor 20 during the operation of portable communication device 50, and may be used to store user data such as the conditions for when a message is to be transmitted by portable communication device 50. Memory 35 may be provided my one or more different types of memory. For example, memory 35 may be volatile memory (any type of random access memory) or non-volatile memory, such as flash memory, although the scope of the present invention is not limited in this respect.

In accordance with an embodiment of the present invention, I/O module 30 may be used by a user to generate a message. The message may be displayed with display 25 and stored in memory 35. The user may also indicate or define the conditions for when the message may be transmitted. Thus, when processor 20 determines that the user defined condition or conditions has been met, portable communication device 50 may use transmitter 40 with antennae 45 to transmit the message to a wireless communication network 90 with a radio frequency (RF) signal (shown in FIG. 1 as an arrow 45). Note, portable communication device 50 may use one of the communication protocols listed above to transmit the message. The scope of the present invention is not limited as to the type of system that receives the message. For example, wireless communication network may be a cellular network, a wireless local area network (WLAN), a Bluetooth™ piconet, etc.

The transmission may be received by an antennae 70 connected to a base station 75. Base station 75 may then transmit the message to a receive using the public switched telephone network (PSTN) 80. It should be understood that the scope of the present invention is not limited as to the type of device that receives the message from portable communication device 50. For example, the message may ultimately be transmitted to a wired communication device or another portable communication device (not shown). It should also be understood that the scope of the present invention is not limited to embodiments where a message is sent from a portable communication device to a receiver over a wireless communication network. In alternative embodiments, a message may be transmitted from the wireless communication network to a portable communication device (i.e., portable communication device 50).

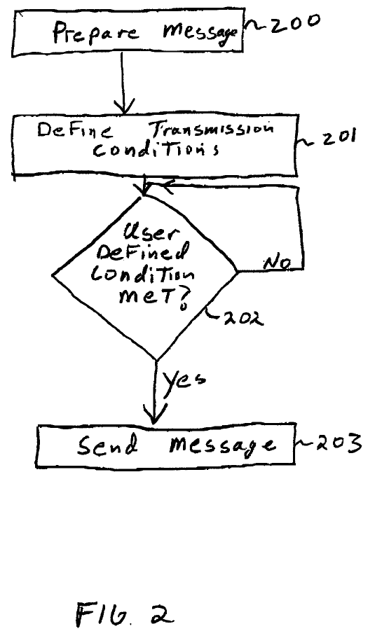

Turning now to FIG. 2, a method in accordance with an embodiment of the present invention is provided. This embodiment may begin with a user generating a message to be sent, step 200. The message may comprise any combination of voice, data, music, content, etc. The message may be generated using an I/O device (e.g. I/O module 30 of FIG. 1) and stored in memory within the portable communication device. It may desirable to perform some processing on the message once it has been created. For example, it may be desirable to encrypt or compress the message prior to it being transmitted, although this additional processing should be considered optional.

If the processing is to be performed, it may be desirable to postpone the processing of the message if portable communication device 50 is being powered by a battery. Instead, the compression, encryption, etc. may be delayed until portable communication device 50 is connected to a stable power supply (i.e., plugged into the wall). This may be desirable to save power associated with the processing that would otherwise drain the battery of portable device 50.

In generating the message, a user may also define the conditions under which portable communication device 50 is to transmit the message, step 201. The user may specify a user defined event upon whose occurrence the message is transmitted to wireless communication system 90 (see FIG. 1). Although the scope of the present invention is not limited in this respect, one example of a user defined event may include specifying a particular time and/or date for when the message is to be transmitted. Thus, portable communication device 50 may transmit the message when processor 50 detects that the time or date condition has been met. This may allow the user to transmit time sensitive information in real-time, yet prepare the message well in advance of its transmission.

Alternatively, portable communication device 50 may transmit the message to wireless communication network 90 in real-time. However, wireless communication network 90 may store or queue the message in memory until the time and/or date condition specified by the user is met. In other words, wireless communication network 90 may hold the message until the date or time condition is met and then allow the message to be transmitted to the intended receiver(s).

In alternative embodiments, the user may also define acceptable values of other parameters as a user define event that triggers the transmission of the message. For example, the user may specify an acceptable level of quality of service or an acceptable level of security that must be achieved before the message is sent. This may be desirable to provide a desired level of quality or security for the transmission of the message. The user may also specify an acceptable cost for transmitting the message or data rate such as by specifying that transmission over a third generation (i.e. 3G) system or particular second generation (i.e. 2G) systems is permissible. This may allow the user to generate the message and then take advantage of lower cost transmission rates (i.e. off-peak fares).

In addition, the user may specify other characteristics of the transmission to reduce the cost or power consumption associated with the transmission. To reduce the amount of power consumption, and thus perhaps increase the life of the battery, the user may specify an acceptable level of transmission power for the transmitter in the portable communication device (i.e. transmitter 40) or an acceptable distance between the portable communication device and the base station to which it is transmitting. Accordingly, the user may be able to extend the life of the battery of the portable communication device by taking advantage of the possibility of transmitting the message at a lower power level. This may be possible, for example, if the user happens to be traveling towards the base station with which it is in communication.

The user may also specify that the message is not to be sent until the portable communication device is connected to a stable power supply. For example, the user defined event may be the plugging of the portable communication device into a re-charger or into the wall.

Although the scope of the present invention is not limited in this respect both the message and the user defined event may be stored in the memory with in the portable communication device (e.g. memory 35 of FIG. 1). It should also be understood that the scope of the present invention is not limited to embodiments where the user defined event consists of a single criteria. In alternative embodiments, the user defined event may comprise more than one criteria such as all or any combination of those described above. The user may also specify that different message may be sent if particular sequence of user defined events occur. For example, one message may be sent if one user defined event occurs, yet send another message if a different user defined event occurs first. It should also be understood that a user defined event may not be trigger upon the occurrence of a maximum or minimum value. In alternative embodiments, the user may specify an acceptable range of values or condition those values based on other characteristics.

In alternative embodiments, the user may also specify other characteristics for the message. For example, the user may specify to the wireless communication network that the ringer on the receiver is not to be activated with the message is sent. This may be desirable to allow the content of the message to be sent to the receiver with disturbing the receiver. This may be advantageous if the receiver is in another time zone or if the information is not urgent.

The processor within the portable communication device (e.g. processor 20) may then monitor the operation of the portable communication device to determined if the user defined event has occurred, step 202. When the user defined event has occurred, the message may be retrieved from memory and transmitted to a wireless communication network (e.g. wireless communication network 90) using transmitter 40 and antennae 45, step 203.

While certain features of the invention have been illustrated and described herein, many modifications, substitutions, changes, and equivalents will now occur to those skilled in the art. For example, embodiments of the present invention may be used to delay or condition the transmission of a message from a wireless communication network (i.e. a base station) to a portable communication device. For example, a message may not be sent to a portable communication device unless a condition defined by the user occurs. It is, therefore, to be understood that the appended claims are intended to cover all such modifications and changes as fall within the true spirit of the invention.

1. A method of transmitting a message from a portable communication device comprising:
preparing the message to be transmitted; and
transmitting the message from the portable communication device upon the occurrence of a user defined event.

2. The method of claim 1, wherein transmitting the message includes transmitting the message from the portable communication device to a base station.

3. The method of claim 1, further comprising specifying the user defined event.

4. The method of claim 3, wherein specifying the user defined event includes specifying the date and time for transmission of the message.

5. The method of claim 3, wherein specifying the user defined event includes specifying an acceptable cost level at which the message is to be sent.

6. The method of claim 3, wherein specifying the user defined event includes specifying an acceptable transmission power level at which the message is to be sent.

7. The method of claim 3, wherein specifying the user defined event includes specifying an acceptable security level at which the message is to be sent.

8. The method of claim 3, wherein specifying the user defined event includes specifying an acceptable distance from a base station at which the message is to be sent.

9. The method of claim 1, further comprising compressing the message only when the portable communication device is coupled to a stable power supply.

10. The method of claim 1, wherein transmitting the message includes wirelessly transmitting the message to a receiver and disabling a ringing function of the receiver.

11. The method of claim 1, further comprising storing the message in memory in the portable communication device.

12. The method of claim 11, wherein storing the message in memory includes storing the message in non-volatile memory.

13. A method of transmitting a message to a portable communication device comprising:
storing a message in memory;
defining a transmission condition for when the message is to be transmitted
transmitting the message with a transmitter to the portable communication device upon occurrence of the transmission condition.

14. The method of claim 13, wherein defining a transmission condition includes defining a time when the message is to be transmitted.

15. The method of claim 13, wherein defining a transmission condition includes defining an acceptable security level for when the message is to be transmitted.

16. The method of claim 13, wherein defining a transmission condition includes defining an acceptable quality of service level for when the message is to be transmitted.

17. The method of claim 13, wherein defining a transmission condition includes defining an acceptable cost for when the message is to be transmitted.

18. The method of claim 13, further comprising receiving the message with an antennae on the portable communication device.

19. A portable communication device comprising:
a memory to store a message;
a transmitter having an antennae to transmit the message; and
a processor, wherein the processor is adapted to transmit the message with the transmitter upon occurrence of a user defined event.

20. The portable communication device of claim 19, where in the processor is further adapted to monitor the operation of the portable communication device and determine if the user defined event has occurred.

21. The portable communication device of claim 20, wherein the processor is further adapted to determine if a current time is substantially equal to a time specified as at least part of the user defined event.

22. The portable communication device of claim 20, wherein the processor is further adapted to determine if a current system security level is substantially equal to an acceptable security level specified as at least part of the user defined event.

23. The portable communication device of claim 20, wherein the processor is further adapted to determine if a current quality of service level is substantially equal to an acceptable quality of service level specified as at least part of the user defined event.

24. An article comprising: a storage medium having stored thereon instructions, that, when executed by a computing platform, results in:
preparing a message to be transmitted by a portable communication device; and
transmitting the message from the portable communication device upon the occurrence of a user defined event.

25. The article of claim 24, wherein the instructions, when executed, further result in transmitting the message from the portable communication device to a base station.

26. The article of claim 24, wherein the instructions, when executed, further result in specifying the user defined event.

27. The article of claim 26, wherein the instructions, when executed, further result in specifying an acceptable quality of service level at which the message is to be transmitted.

28. The article of claim 26, wherein the instructions, when executed, further result in specifying a n acceptable level of service level at which the message is to be transmitted.
